(19) United States
(12) Patent Application Publication
(10) Pub. No.: US 2026/0260811 A1
(43) Pub. Date: Sep. 3, 2026

(54) MULTILAYER CERAMIC ELECTRONIC COMPONENT AND METHOD FOR MANUFACTURING THE SAME

(71) Applicant: TAIYO YUDEN CO., LTD., Tokyo (JP)

(72) Inventor: Shoji KUSUMOTO, Takasaki-shi (JP)

(21) Appl. No.: 19/455,677

(22) Filed: Jan. 21, 2026

(30) Foreign Application Priority Data
Feb. 28, 2025 (JP) 2025-031622

(51) Int. Cl. H01G 4/224; H01G 4/12; H01G 4/232; H01G 4/248; H01G 4/30; H01G 13/00

(52) U.S. Cl. CPC H01G 4/224; H01G 4/232; H01G 4/248; H01G 4/30; H01G 13/003; H01G 4/12; H01G 13/006

(57) ABSTRACT

A multilayer ceramic electronic component includes an element body that includes: a laminated body including a capacitive part, cover parts; and side margin parts. The laminated body has a plurality of ridge portions extending in a third direction orthogonal to first and second directions, and the element body has a projecting part at at least one of the plurality of ridge portions. The projecting part is continuous with one of the side margin parts. In a cross section including the first and second directions, the projecting part projects outward in the first direction beyond a center point, in the second direction, of a principal face and spreads toward the center point beyond the boundary line between the laminated body and the side margin part.

### CROSS-REFERENCES TO RELATED APPLICATIONS

The present application claims priority to Japanese Patent Application No. 2025-031622, filed Feb. 28, 2025, the disclosure of which is incorporated herein by reference in its entirety including any and all particular combinations of the features disclosed therein.

### BACKGROUND OF THE INVENTION

### 1. Field of the Invention

The present invention relates to a multilayer ceramic electronic component and a method for manufacturing the same.

### 2. Description of the Related Art

Multilayer ceramic electronic components such as multilayer ceramic capacitors each having a capacitive part including alternately laminated internal electrodes and dielectric layers are a known art. In recent years, the development of electronic devices such as smartphones has been progressing, and this has led to a demand for multilayer ceramic capacitors with higher capacitance and smaller size. One proposal to meet this demand is to form side margin parts afterward (see, for example, Japanese Unexamined Patent Application Publication No. 2012-209539).

Meanwhile, with the expanding applications of multilayer ceramic capacitors, they are being used more frequently under high-voltage conditions. Therefore, the multilayer ceramic capacitors are also required to exhibit reliability at high voltages. The multilayer ceramic capacitor is a piezoelectric body. Therefore, as its service voltage increases, the multilayer ceramic capacitor may be cracked due to expansion or distortion of the multilayer portion caused by the piezoelectric effect. One possible approach to improve the reliability at high voltages is to increase the thickness of the side margin parts to form a configuration capable of preventing the occurrence of cracks. However, when the thickness of the side margin parts is increased, the relative volume of the capacitive part decreases, and this hinders the multilayer ceramic capacitor from achieving high capacitance and a small size. Specifically, with the previous proposal, it is difficult to achieve improved reliability at high voltages, increased capacitance, and reduced size simultaneously.

### SUMMARY OF THE INVENTION

Accordingly, an object of the invention is to achieve improved reliability at high voltages, increased capacitance, and reduced size simultaneously.

One aspect to achieve the above object provides a multilayer ceramic electronic component including: an element body that includes a laminated body including a capacitive part formed by alternately laminating first internal electrode layers and second internal electrode layers in a first direction with dielectric layers interposed therebetween and further including a pair of cover parts covering the capacitive part from both sides in the first direction and that further includes a side margin part covering the laminated body in a second direction orthogonal to the first direction, the element body having a pair of principal faces facing each other in the first direction; a first external electrode that is formed on a surface of the element body and that is connected to the first internal electrode layers; and a second external electrode that is formed on a surface of the element body so as to be spaced apart from the first external electrode and that is connected to the second internal electrode layers, wherein the laminated body has a plurality of ridge portions extending in a third direction orthogonal to the first direction and the second direction, and wherein the element body has a projecting part at at least one of the plurality of ridge portions, wherein the projecting part is continuous from the side margin parts at one of the plurality of ridge portions, that extends in the third direction, and that, in a cross-section defined by the first direction and the second direction, projects outward in the first direction beyond a center point of one of the principal faces as viewed in the second direction, as well as spreads toward the center point of the one of the principal faces in the second direction beyond a boundary line between the laminated body and the side margin part.

In the multilayer ceramic electronic component according to the above aspect, in plan view where the one of the principal faces is observed, the projecting part includes a central region at least partially overlapping the capacitive part, and end regions extending in the third direction on both sides of the central region, and a dimension D1 of an extending portion that extends beyond the boundary line in the second direction in each of the end regions, is smaller than a dimension D2 of an extending portion that extends beyond the boundary line in the second direction in the central region.

Also, in the multilayer ceramic electronic component according to the above aspect, in plan view where the one of the principal faces is observed, the projecting part includes a central region at least partially overlapping the capacitive part and end regions extending in the third direction on both sides of the central region, and a dimension M1 of the projecting part in the first direction in each of the end regions is smaller than a dimension M2 of the projecting part in the first direction in the central region.

Moreover, in the multilayer ceramic electronic component according to the above aspect, the dimension D1, in the second direction, of the extending portion extending beyond the boundary line in each of the end regions and the dimension D2, in the second direction, of the extending portion extending beyond the boundary line in the central region may satisfy the following relations: 0 μm≤D1, and 0 μm<D2≤W× 1/10, where W is a dimension of the multilayer ceramic electronic component in the second direction.

Further, in the multilayer ceramic electronic component according to the above aspect, the dimension M1 of the projecting part in the first direction in each of the end regions may satisfy the following relation: 0 μm≤M1<T× 1/20, where Tis a dimension of the multilayer ceramic electronic component in the first direction, and the dimension M2 of the projecting part in the first direction in the central region may satisfy the following relation: 0 μm<M2≤T× 1/10.

In addition, in the multilayer ceramic electronic component according to the above aspect, the projecting part is formed in at least one of two ridge portions of the plurality of ridge portions paired in the first direction, the two ridge portions being paired and facing each other in the first direction in the cross-section defined by the first direction and the second direction.

Also, in the multilayer ceramic electronic component according to the above aspect, the projecting part is formed in at least one of two ridge portions of the plurality of ridge portions paired in the second direction, the two ridge portions being paired and facing each other in the second direction in the cross-section defined by the first direction and the second direction.

Further, in the multilayer ceramic electronic component according to the above aspect, the first external electrode and the second external electrode may coat respective end faces of the element body facing each other in the third direction and may extend along at least the principal faces, and outermost positions of the first external electrode and the second external electrode in the first direction may be located at a central portion of the element body in the second direction. A dimension of the multilayer ceramic electronic component in the first direction may be defined as a distance between the outermost positions of the first external electrode or the second external electrode in the first direction.

In the multilayer ceramic electronic component according to the above aspect, end parts, in the second direction, of the first internal electrode layer and the second internal electrode layer may be aligned within a range of 0.5 μm in the second direction.

Another aspect to achieve the above object provides a multilayer ceramic electronic component manufacturing method including the steps of: producing an unsintered laminated body that includes a capacitive part formed by alternately laminating dielectric layers and internal electrodes in a first direction with the internal electrodes exposed at a side face facing a second direction orthogonal to the first direction and that further includes a pair of cover parts that coat the capacitive part from both sides in the first direction; forming a side margin part on the side face of the unsintered laminated body by pressing the side face against a sheet member placed on a first elastic material to punch the sheet member; forming spread portions by pressing the side margin part against a rigid plate to spread the sheet member forming the side margin part over a region larger than an area of the side face in the first direction; pressing the side margin part having the spread portions against a second elastic material such that the spread portions deform and are wrapped around edges of a pair of principal faces of the laminated body, respectively, that face each other in the first direction to form projecting parts projecting outward in the first direction, respectively, thereby obtaining an unsintered element body; firing the element body; and forming an external electrode on the fired element body.

In the multilayer ceramic electronic component manufacturing method according to the above aspect, a hardness of the second elastic material may be lower than a hardness of the first elastic material.

Further, in the multilayer ceramic electronic component manufacturing method according to the above aspect, the rigid plate may include a spread-preventing portion for preventing the sheet member forming the side margin part from spreading toward a pair of end faces of the laminated body that face each other in a third direction orthogonal to the first direction and the second direction.

### BRIEF DESCRIPTION OF THE DRAWINGS

FIG. 1A is a perspective view of a multilayer ceramic capacitor according to an embodiment of the invention.

FIG. 1B is a plan view when a principal face of a ceramic body included in the multilayer ceramic capacitor is observed.

FIG. 2 is an enlarged plan view of the multilayer ceramic capacitor shown in FIG. 1B.

FIG. 3A is a cross-sectional view of the multilayer ceramic capacitor taken along line AA-AA in FIG. 1B.

FIG. 3B is a cross-sectional view of the multilayer ceramic capacitor taken along line B-B in FIG. 1B.

FIG. 4A is a cross-sectional view of the ceramic body included in the multilayer ceramic capacitor, the cross-sectional view being taken along line A-A in FIG. 1B.

FIG. 4B is a cross-sectional view of the ceramic body included in the multilayer ceramic capacitor, the cross-sectional view being taken along line B-B in FIG. 1B.

FIG. 5A is an enlarged view of portion X1 in FIG. 4A.

FIG. 5B is an enlarged view of portion X2 in FIG. 4B.

FIG. 6A is a cross-sectional view of the multilayer ceramic capacitor taken along line A-A in FIG. 1B.

FIG. 6B is a cross-sectional view of the multilayer ceramic capacitor taken along line B-B in FIG. 1B.

FIG. 6C is a cross-sectional view of a multilayer ceramic capacitor in a comparative embodiment, the cross-sectional view corresponding to FIG. 6A.

FIG. 7 is a flowchart showing an example of a multilayer ceramic capacitor manufacturing method in an embodiment.

FIG. 8 is a perspective view showing a multilayer ceramic capacitor manufacturing process in the embodiment.

FIG. 9 is a perspective view showing the multilayer ceramic capacitor manufacturing process in the embodiment.

FIGS. 10A and 10B are schematic cross-sectional views showing the multilayer ceramic capacitor manufacturing process in the embodiment.

FIGS. 11A and 11B are schematic cross-sectional views showing the multilayer ceramic capacitor manufacturing process in the embodiment.

FIGS. 12A and 12B are schematic cross-sectional views showing the multilayer ceramic capacitor manufacturing process in the embodiment.

FIG. 13 is a perspective view showing the multilayer ceramic capacitor manufacturing process in the embodiment.

FIGS. 14A and 14B are cross-sectional views showing multilayer ceramic capacitors in modifications.

### DESCRIPTION OF THE PREFERRED EMBODIMENTS

Embodiments of the invention will next be described with reference to the drawings. In the drawings, mutually orthogonal T, W, and L direction axes are shown as appropriate. The T, W, and L directions are the same for all the drawings. The T, W, and L directions correspond to first, second, and third directions, respectively.

### [Overall Configuration of Multilayer Ceramic Capacitor 10]

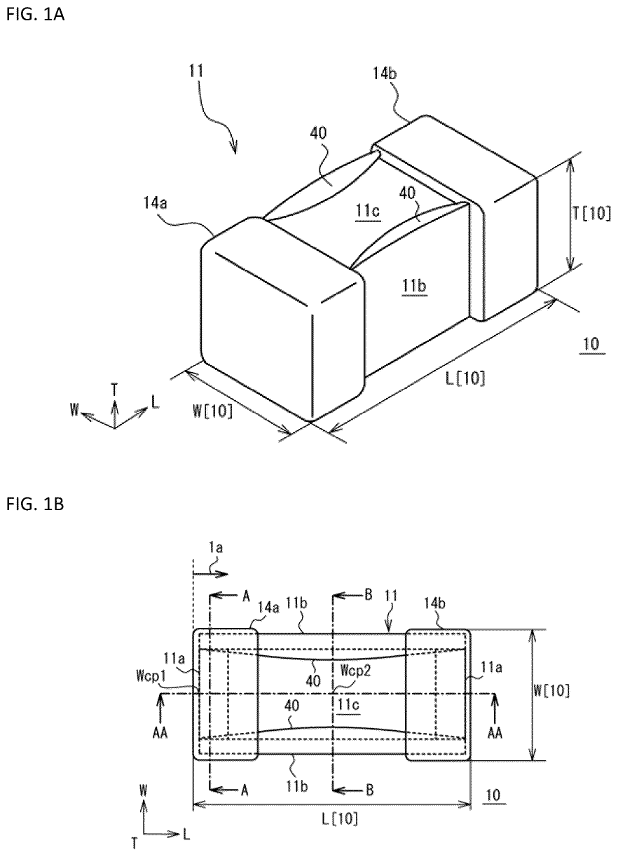

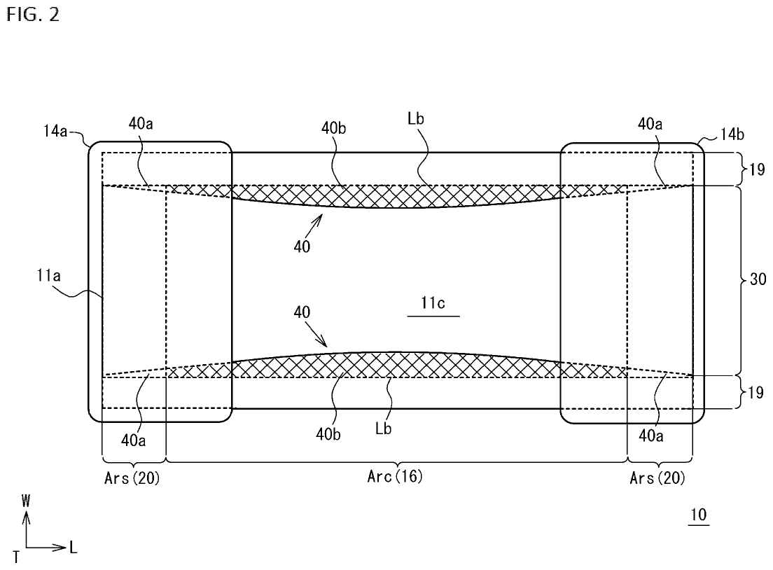

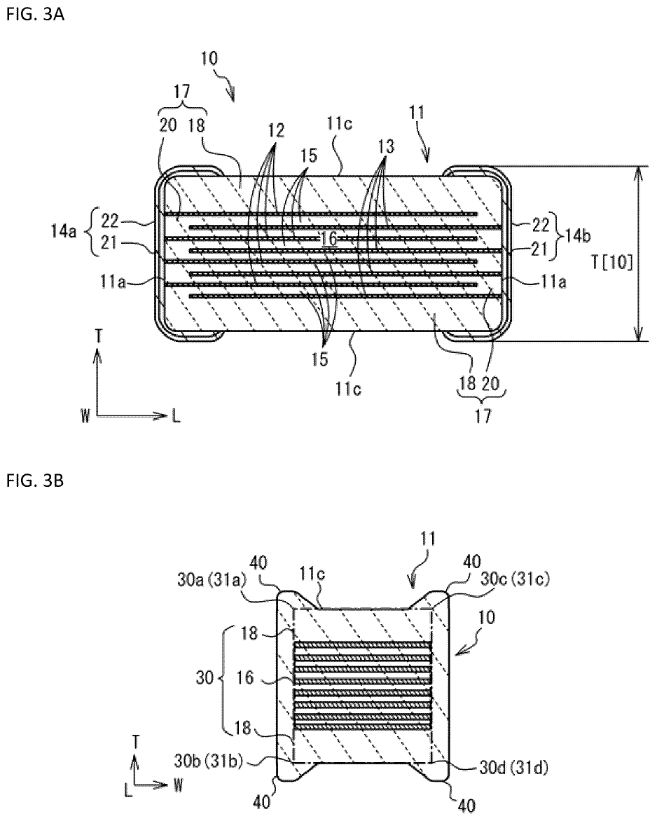

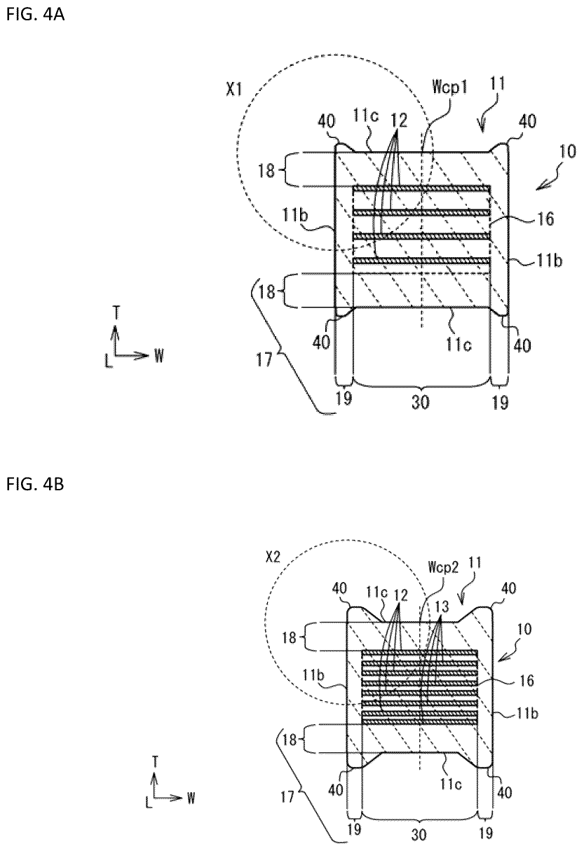

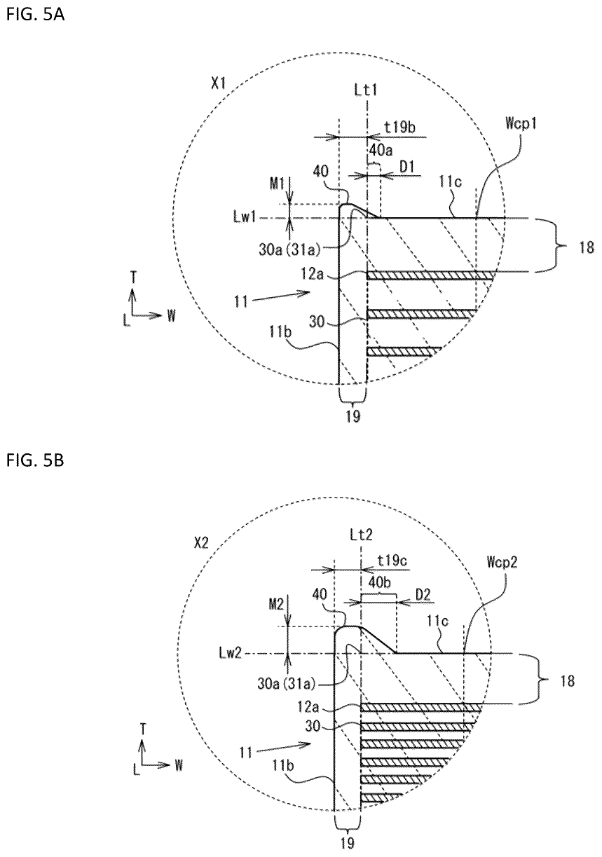

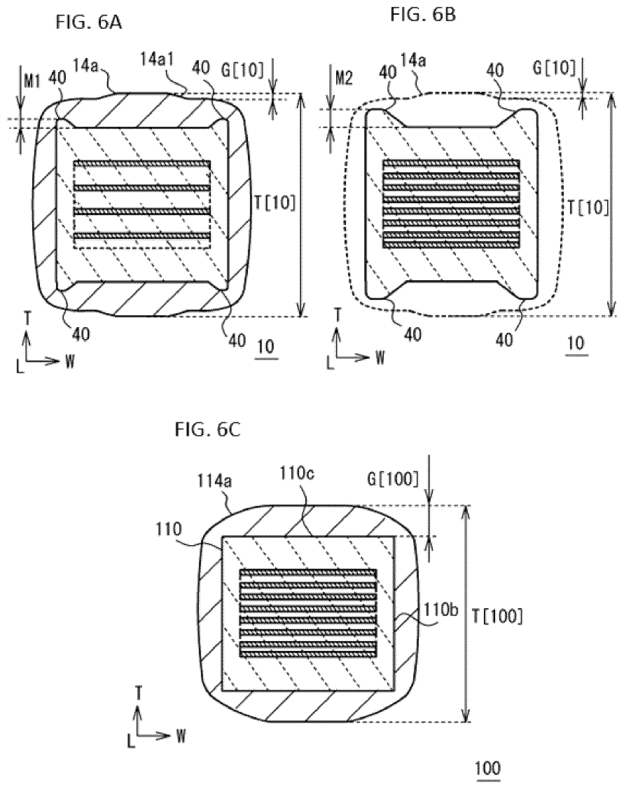

FIGS. 1A to 6B are illustrations showing an example of a multilayer ceramic capacitor 10 according to an embodiment of the invention. FIG. 1A is a perspective view of the multilayer ceramic capacitor 10, and FIG. 1B is a plan view when a principal face 11c of a ceramic body 11 included in the multilayer ceramic capacitor 10 is observed. FIG. 2 is an enlarged plan view of the multilayer ceramic capacitor 10 shown in FIG. 1B. FIG. 3A is a cross-sectional view of the multilayer ceramic capacitor 10 taken along line AA-AA in FIG. 1B. FIG. 3B is a cross-sectional view of the multilayer ceramic capacitor 10 taken along line B-B in FIG. 1B. FIG. 4A is a cross-sectional view of the ceramic body 11 included in the multilayer ceramic capacitor 10, the cross-sectional view being taken along line A-A in FIG. 1B. FIG. 4B is a cross-sectional view of the ceramic body 11 included in the multilayer ceramic capacitor 10, the cross-sectional view being taken along line B-B in FIG. 1B. FIG. 5A is an enlarged view of portion X1 in FIG. 4A. FIG. 5B is an enlarged view of portion X2 in FIG. 4B. FIG. 6A is a cross-sectional view of the multilayer ceramic capacitor 10 taken along line A-A in FIG. 1B. FIG. 6B is a cross-sectional view of the multilayer ceramic capacitor 10 taken along line B-B in FIG. 1B. Note that FIG. 6C is a cross-sectional view of a multilayer ceramic capacitor in a comparative embodiment, the cross-sectional view corresponding to FIG. 6A.

The multilayer ceramic capacitor 10 includes the ceramic body 11 having a roughly rectangular parallelepiped shape. The ceramic body 11 has a pair of end faces 11a facing each other in the L direction, a pair of principal faces 11c facing each other in the T direction, and a pair of side faces 11b facing each other in the W direction. The end faces 11a, the side faces 11b, and the principal faces 11c are formed as, for example, substantially flat surfaces but may be rounded surfaces.

A first external electrode 14a and a second external electrode 14b are disposed on the surface of the ceramic body 11 so as to be spaced apart from each other. In the example shown in FIGS. 1A to 3A, the first external electrode 14a is disposed on one of the end faces 11a facing each other, and the second external electrode 14b is disposed on the other. The first external electrode 14a and the second external electrode 14b each extend also along the side faces 11b and the principal faces 11c adjacent to the end faces 11a. However, the first external electrode 14a and the second external electrode 14b are spaced apart from each other.

It should be noted that the first external electrode 14a and the second external electrode 14b may be disposed at any positions on the surfaces of the ceramic body 11 so long as they are spaced apart from each other. For example, the first external electrode 14a and the second external electrode 14b may be disposed on the same surface of the ceramic body 11 so as to be spaced apart from each other. Alternatively, the first external electrode 14a and the second external electrode 14b may be disposed on respective two surfaces of the ceramic body 11 that are adjacent to each other or respective two surfaces facing each other so as to be spaced apart from each other.

The first external electrode 14a and the second external electrode 14b may each extend from one surface of the ceramic body 11 to any other surface so long as they are spaced apart from each other. For example, each external electrode may extend to an adjacent surface and may further extend to a surface adjacent thereto.

Note that, the multilayer ceramic capacitor has the first direction, which is a lamination direction, the second direction, which is a direction perpendicular to the lamination direction and intersects two mutually-facing surfaces, and the third direction, which is a direction perpendicular to the first and second directions and intersects two mutually-facing surfaces. The first, second, and third directions are orthogonal to each other. The lamination direction may be any of the length, width, and height directions of the ceramic body 11.

The ceramic body 11 has a configuration including dielectric layers 15 containing a ceramic material serving as a dielectric and internal electrode layers that are laminated alternately. The internal electrode layers include a plurality of first internal electrode layers 12 and a plurality of second internal electrode layers 13. The first internal electrode layers 12 and the second internal electrode layers 13 are laminated alternately. In the illustrated example, edges of the first internal electrode layers 12 are extracted at one end face 11a of the ceramic body 11 on which the first external electrode 14a is disposed. Edges of the second internal electrode layers 13 are extracted at the other end face 11a of the ceramic body 11 on which the second external electrode 14b is disposed.

In this manner, the first internal electrode layers 12 are electrically conducted with the first external electrode 14a, and the second internal electrode layers 13 are electrically conducted with the second external electrode 14b. Therefore, the ceramic body 11 has a configuration including capacitor units laminated one on another, i.e., a capacitive part 16.

The ceramic body 11 includes a protective part 17 that forms a peripheral portion of the capacitive part 16. The surfaces of the protective part 17 form the end faces 11a, the side faces 11b, and the principal faces 11c.

The protective part 17 includes a pair of cover parts 18 that coat the capacitive part 16 from both sides in the T direction, side margin parts 19 that coat the capacitive part 16 from both sides in the W direction, and end margins 20 located in outer portions, in the L direction, of the capacitive part 16.

The cover parts 18 are located on the outer sides, in the lamination direction, of the capacitive part 16, i.e., on the outer sides, in the T direction, of the capacitive part 16 in the illustrated example. The side margin parts 19 are disposed on the outer sides, in a direction perpendicular to the lamination direction, of the capacitive part 16. The side margin parts 19 are disposed as regions that do not include the edges of the first and second internal electrode layers 12 and 13 that are extracted at surfaces of the ceramic body 11 in directions perpendicular to the lamination direction. Specifically, in the illustrated example, the side margin parts 19 are located on the outer sides, in the W direction, of the capacitive part 16. The end margins 20 are disposed in outer portions, in a direction perpendicular to the lamination direction, of the capacitive part 16. The end margins 20 are extracted as regions that include edges of the first and second internal electrode layers 12 and 13 that are extracted at surfaces of the ceramic body 11 in a direction perpendicular to the lamination direction. Specifically, in the illustrated example, the end margins 20 are located in the outer portions, in the L direction, of the capacitive part 16.

The capacitive part 16 and the pair of cover parts 18 that coat the capacitive part 16 form a laminated body 30. Referring to FIG. 3B, the laminated body 30 has four ridge portions 31a, 31b, 31c, and 31d. The four ridge portions 31a, 31b, 31c, and 31d are formed as continuous sequences of corner parts 30a, 30b, 30c, and 30d such as those observed in the cross-section shown FIG. 3B so as to extend in the L direction. In the laminated body 30, end parts, in the W direction, of the first internal electrode layers 12 and the second internal electrode layers 13 are aligned within the range of 0.5 μm in the W direction.

The ceramic body 11 has the four ridge portions 31a, 31b, 31c, and 31d extending in the third direction and connecting surfaces of the laminated body 30 and further has projecting parts 40 of the side margin parts 19 that coat the ridge portions 31a, 31b, 31c, and 31d. One of the four ridge portions, i.e., the ridge portion 31a, will be described as a representative. The ridge portion 31a is formed as a continuous sequence of corner parts 30a extending in the L direction. In the enlarged cross-section shown in FIG. 5A, i.e., a cross-section at a position spaced from one of the end parts, in the L direction, of the multilayer ceramic capacitor 10 shown in FIG. 1B in the direction indicated by arrow 1a by 1/20 of the length dimension L[10] of the multilayer ceramic capacitor 10 in the L direction (this cross-section is hereinafter referred to as an end-side WT cross-section), the corner part 30a is the intersection of a first directional first virtual line Lt1 and a second directional first virtual line Lw1. Also, in the enlarged cross-section shown in FIG. 5B, i.e., a cross-section at a position spaced from one of the end parts, in the L direction, of the multilayer ceramic capacitor 10 shown in FIG. 1B in the direction indicated by arrow 1a by ½ of the length dimension L[10] of the multilayer ceramic capacitor 10 in the L direction (this cross-section is hereinafter referred to as an central WT cross-section), the corner part 30a is the intersection of a first directional second virtual line Lt2 and a second directional second virtual line Lw2. Depending on the orientation of the coordinate axes, two cross-sections of the multilayer ceramic capacitor 10 can be defined as the end-side WT cross-section, and any one of the cross-sections may be used as the end-side WT cross-section.

The first directional first virtual line Lt1 is an extension line of the joint boundary line between the laminated body 30 and the side margin part 19 in the cross-section shown in FIG. 5A, i.e., the end-side WT cross-section. The material, sintered state, etc. of the laminated body 30 differ from those of the side margin part 19. Therefore, by observing the joint boundary line, the first directional first virtual line Lt1 can be defined. If the joint boundary line is unclear or cannot be observed, a straight line connecting end parts of the first internal electrode layers 12 and the second internal electrode layers 13 in the T direction can be defined as the boundary line. However, the positions of the end parts of the first internal electrode layers 12 and the second internal electrode layers 13 may be slightly displaced from each other in the W direction. In this case, a virtual straight line extending in the T direction is moved from the outer side, in the W direction, of the ceramic body 11 toward the inner side. Then the virtual straight line at the position where it first comes into contact with any of the first internal electrode layers 12 and the second internal electrode layers 13 is defined as the first directional first virtual line Lt1.

On the other hand, the second directional first virtual line Lw1 is a straight line extending from a principal face 11c of the ceramic body 11 in the W direction in the cross-section shown in FIG. 5A, i.e., the end-side WT cross-section. However, the principal face 11c may have a shape with its central portion in the W direction projecting in the T direction. In this case, a virtual straight line extending in the W direction is moved from the outer side, in the T direction, of the ceramic body 11 toward the inner side. Then the virtual straight line at the position where it first comes into contact with the principal face 11c is defined as the second directional first virtual line Lw1.

The first directional second virtual line Lt2 is an extension line of the joint boundary line between the laminated body 30 and the side margin part 19 in the cross-section shown in FIG. 5B, i.e., the central WT cross-section. The material, sintered state, etc. of the laminated body 30 differ from those of the side margin part 19. Therefore, by observing the joint boundary line, the first directional second virtual line Lt2 can be defined. If the joint boundary line is unclear or cannot be observed, a line connecting end parts of the first internal electrode layers 12 and the second internal electrode layers 13 in the T direction can be defined as the boundary line. However, the positions of the end parts of the first internal electrode layers 12 and the second internal electrode layers 13 may be slightly displaced from each other in the W direction. In this case, a virtual straight line extending in the T direction is moved from the outer side, in the W direction, of the ceramic body 11 toward the inner side. Then the virtual straight line at the position where it first comes into contact with any of the first internal electrode layers 12 and the second internal electrode layers 13 is defined as the first directional second virtual line Lt2.

On the other hand, the second directional second virtual line Lw2 is a straight line extending from a principal face 11c of the ceramic body 11 in the W direction in the cross-section shown in FIG. 5B, i.e., the central WT cross-section. However, the principal face 11c may be rounded and have a shape with its central portion in the W direction projecting in the T direction. In this case, a virtual straight line extending in the W direction is moved from the outer side, in the T direction, of the ceramic body 11 toward the inner side. Then the virtual straight line at the position where it first comes into contact with the principal face 11c is defined as the second directional second virtual line Lw2.

It should be noted that the same definitions can be applied to the other corner parts 30b to 30d. The continuous sequences of corner parts 30b to 30d extending in the L direction form the ridge portions 31b to 31d.

The projecting parts 40 are continuous from the side margin parts 19 and each extend in a band in the L direction (see FIG. 2). As shown in FIGS. 4A to 5B, each of the projecting parts 40 projects outward in the T direction beyond a center point Wcp1 or Wcp2, in the W direction, of a principal face 11c in a cross section including the T direction and the W direction, i.e., the end-side WT cross-section or the central WT cross-section. Also, as shown in FIGS. 5A and 5B, each of the projecting parts 40 extends toward the center point Wcp1 or Wcp2 of the principal face 11c beyond the first directional first virtual line Lt1 or the first directional second virtual line Lt2 in a cross-section including the T direction and the W direction, i.e., the end-side WT cross-section or the central WT cross-section. It should be noted that the center point Wcp1 is a point located at the center in the W direction in the cross-section taken along cutting line A-A on one end part side in FIG. 1A. The center point Wcp2 is a point at the center in the W direction in the cross-section taken along cutting line B-B in a central portion in FIG. 1A. It is only necessary that at least one of the four ridge portions 31a, 31b, 31c, and 31d be provided with a projecting part 40. The projecting parts 40 will be described later in detail.

The capacitive part 16 is disposed on the inner side of the protective part 17 and forms a function part. The capacitive part 16 includes the multiple first internal electrode layers 12 and the multiple second internal electrode layers 13 that are laminated in the T direction with the dielectric layers 15 interposed therebetween (see FIG. 2). The internal electrode layers 12 and 13 are each sheet-shaped extending along the L-W plane and are arranged alternately in the T direction.

The first internal electrode layers 12 and the second internal electrode layers 13 are formed of a good electrical conductor and function as internal electrodes of the multilayer ceramic capacitor 10. The good electrical conductor used to form the first internal electrode layers 12 and the second internal electrode layers 13 is a material composed mainly of a base metal such as nickel (Ni), copper (Cu), or tin (Sn) or an alloy containing any of these metals. A noble metal such as platinum (Pt), palladium (Pd), silver (Ag), or gold (Au) or an alloy containing any of these metals may also be used as the main component of the first internal electrode layers 12 and the second internal electrode layers 13. The main component of the first internal electrode layers 12 may be the same as or different from the main component of the second internal electrode layers 13.

The dielectric layers 15 are formed of a dielectric ceramic. In the multilayer ceramic capacitor 10, a dielectric ceramic with a high dielectric constant is used in order to increase the capacitance of the dielectric layers 15 between the first internal electrode layers 12 and the second internal electrode layers 13. Examples of the dielectric ceramic with a high dielectric constant include materials having a perovskite structure containing barium (Ba) and titanium (Ti) and typified by barium titanate (BaTiO₃).

In addition to the barium titanate-based dielectric ceramics, the dielectric ceramic may be, for example, strontium titanate (SrTiO₃)-based, calcium titanate (CaTiO₃)-based, magnesium titanate (MgTiO₃)-based, calcium zirconate (CaZrO₃)-based, calcium zirconate titanate (Ca(Zr,Ti)O₃)-based, barium zirconate (BaZrO₃)-based, and titanium oxide (TiO₂)-based dielectric ceramics. The above-listed dielectric ceramics can be used as the main component of the dielectric layers 15.

The dielectric layers 15 may contain Si (silicon) in addition to the main component described above.

The protective part 17 also is formed of a dielectric ceramic. From the viewpoint of inhibiting internal stress etc., it is preferable that the compositional makeup of the main component of the cover parts 18 and the end margins 20 in the protective part 17 is the same as that of the dielectric layers 15. When the compositional makeups of the main components are the same, the efficiency of manufacturing is improved.

The main component of the side margin parts 19 in the protective part 17 is the same as the main component of the dielectric layers 15. However, when the multilayer ceramic capacitor 10 is manufactured, the compositional makeup of the material forming the side margin parts 19 is adjusted such that, for example, the content of a plasticizer is larger than that in the material forming the dielectric layers 15 and the cover parts 18, i.e., the material forming the laminated body 30, or the amount of a resin such as a binder is larger than that in the material forming the laminated body 30. The reason for this is to allow the side margin parts to deform at a lower temperature and a lower pressure than the dielectric layers 15 and the cover parts 18 when the side margin parts are formed.

The sintering property of the side margin parts 19 manufactured in the manner described above may be poorer than that of the dielectric layers 15 and the cover parts 18, i.e., the laminated body 30. To compensate for this, the amount of Si etc. added may be increased. When the sintering property of the laminated body 30 differs from the sintering property of the side margin parts 19, the adhesion strength of the side margin parts 19 may deteriorate, which is undesirable. However, an advantage in this case is that the boundaries between the laminated body 30 and the side margin parts 19 for the virtual lines such as Lt1 and Lt2 can be easily determined.

The first external electrode 14a and the second external electrode 14b each include: a base film 21 formed so as to coat the extraction parts of the first internal electrode layers 12 or the second internal electrode layers 13 and part of the surface of the ceramic body 11; and a plating film 22 formed on the base film 21. The base film 21 is formed, for example, as a sputtered film or a baked film formed by firing an electroconductive paste. The plating film 22 is a film formed by electroplating. The films in the external electrodes 14a and 14b are formed, for example, of a metal or an alloy composed mainly of nickel (Ni), copper (Cu), tin (Sn), palladium (Pd), platinum (Pt), silver (Ag), gold (Au), or Al (aluminum). The external electrodes 14a and 14b may also be formed by applying an electroconductive paste containing a curable resin such as a resin Ag paste by printing and then drying the paste.

The dimensions of the multilayer ceramic capacitor 10 in different directions can be represented by height T[10]×width W[10]×length L[10] as shown in FIG. 1A. The height T[10] is the distance between the outermost positions of the multilayer ceramic capacitor 10 in the T direction. The width W[10] is the distance between the outermost positions of the multilayer ceramic capacitor 10 in the W direction. The length L[10] is the distance between the outermost positions of the multilayer ceramic capacitor 10 in the L direction.

It should be noted that the dimensions of the multilayer ceramic capacitor 10 are, for example, the length L[10]=0.25 mm, the width W[10]=0.125 mm, and the height T[10]=0.125 mm, are the length L[10]=0.4 mm, the width W[10]=0.2 mm, and the height T[10]=0.2 mm, are the length L[10]=0.6 mm, the width W[10]=0.3 mm, and the height T[10]=0.3 mm, are the length L[10]=1.0 mm, the width W[10]=0.5 mm, and the height T[10]=0.5 mm, are the length L[10]=3.2 mm, the width W[10]=1.6 mm, and the height T[10]=1.6 mm, or are the length L[10]=4.5 mm, the width W[10]=3.2 mm, and the height T[10]=2.5 mm, but are not limited to the above dimensions. The dimensions of the multilayer ceramic capacitor 10 may be, for example, such that the length L[10]>the width W[10]≥the height T[10], that the width W[10]>the length L[10]≥the height T[10], that the height T[10]>the length L[10]≥the width W[10], or that the height T[10]>the width W[10]≥the length L[10].

### [Detailed Configuration of Projecting Parts 40]

The projecting parts 40 reinforce the capacitive part 16 and reduce the expansion and distortion of the capacitive part 16 caused by a piezoelectric phenomenon. Specifically, the projecting parts 40 improve the reliability of the multilayer ceramic capacitor 10 at high voltages. Referring to FIGS. 4A to 5B, the projecting parts 40 are continuous with the side margin parts 19. Also, referring to FIG. 2, the projecting parts 40 extend as strips in the L direction. Each of the projecting parts 40 includes a central region Arc and end regions Ars located on both sides of the central region Arc and extending in the L direction.

Line A-A in FIG. 1B crosses one of the end regions Ars. Line B-B in FIG. 1B crosses the central region Arc. The position of line A-A is spaced from one end, in the L direction, of the multilayer ceramic capacitor 10 in the direction indicated by arrow 1a by 1/20 of the dimension L[10] of the multilayer ceramic capacitor 10 in the L direction. The position of line B-B is spaced from one end, in the L direction, of the multilayer ceramic capacitor 10 in the direction indicated by arrow 1a by ½ of the dimension L[10] of the multilayer ceramic capacitor 10 in the L direction.

The central region Arc overlaps the capacitive part 16 in the plan views shown in FIG. 1B and FIG. 2. Each of the end regions Ars is contained in a region in which the first external electrode 14a or the second external electrode 14b is formed. In the present embodiment, the central region Arc overlaps the entire length of the capacitive part 16 in the L direction. However, it is only necessary that the central region Arc overlap at least part of the capacitive part 16. This is because the capacitive part 16 is reinforced also in this case.

Referring to FIG. 5A, the projecting part 40 crosses the first directional first virtual line Lt1 and extends toward the center point Wcp1 of the principal face 11c. The first directional first virtual line Lt1 is a virtual line segment extending in the T direction along a surface of the laminated body 30 that faces the W direction and corresponds to the boundary line between the laminated body 30 and the side margin part 19. The dimension, in the W direction, of an extending portion 40a extending from the first directional first virtual line Lt1 is D1. Also, the dimension of the projecting part 40 in the T direction is M1. In the cross section shown in FIG. 5A, the dimension M1 is the dimension of a portion projecting outward in the T direction with reference to the center point Wcp1 of the principal face 11c. More specifically, the dimension M1 is the distance between the second directional first virtual line Lw1 drawn from the center point Wcp1 of the principal face 11c in the W direction and the apex of the projecting part 40.

Referring to FIG. 5B, the projecting part 40 crosses the first directional second virtual line Lt2 and extends toward the center point Wcp2 of the principal face 11c. The first directional second virtual line Lt2 is a virtual line segment extending in the T direction along a surface of the laminated body 30 that faces the W direction and corresponds to the boundary line between the laminated body 30 and the side margin part 19. The dimension, in the direction W, of an extending portion 40b extending from the first directional second virtual line Lt2 is D2. Also, the dimension of the projecting part 40 in the T direction is M2. In the cross-section shown in FIG. 5B, the dimension M2 is the dimension of a portion projecting outward in the T direction with reference to the center point Wcp2 of the principal face 11c. More specifically, the dimension M2 is the distance between the second directional second virtual line Lw2 drawn from the center point Wcp2 of the principal face 11c in the W direction and the apex of the projecting part 40. It should be noted that in FIG. 2, the extending portions 40b are indicated with a mesh overlay. In FIG. 2 in which the principal face 11c of the multilayer ceramic capacitor 10 is observed in plan view, line segments Lb extending in the L direction are boundary lines, and portions extending from the boundary lines correspond to the extending portions 40b.

The dimensions D1, D2, M1, and M1 can be measured by observing the cross-sections under a length-measuring microscope (optical microscope) or a scanning electron microscope (SEM) at a magnification of 500 to 5000×. Specifically, as for the dimensions D1 and M1, the multilayer ceramic capacitor 10 is first embedded in a resin and polished to a position 1/20 of the L[10] in the direction indicated by arrow 1a in FIG. 1B. Then the dimensions D1 and M1 are measured in an image observed by the SEM etc. The measurement is performed a plurality of times, e.g., 5 times, and the average values can be used as the dimensions. As for the dimensions D2 and M2, the multilayer ceramic capacitor 10 is embedded in a resin and polished to a position ½ of the L[10] in the direction indicated by arrow 1a in FIG. 1B. Then the dimensions D2 and M2 are measured in an image observed by the SEM etc. The measurement is performed a plurality of times, e.g., 5 times, and the average values can be used as the dimensions.

It should be noted that in the present embodiment, the dimensions D1 and M1 are measured in the cross-section taken along line A-A. However, the dimensions D1 and M1 may be measured in another cross-section included in the end regions Ars. Also, in the present embodiment, the dimensions D2 and M2 are measured in the cross-section taken along line B-B. However, the dimensions D2 and M2 may be measured in another cross-section included in the central region Arc.

When the dimension D1 of the extending portion 40a is compared with the dimension D2 of the extending portion 40b, the relation D1<D2 holds. This is because, since increasing the dimension D2 of the portion overlapping the capacitive part 16 can reinforce the capacitive part 16, the expansion and distortion of the capacitive part 16 caused by a piezoelectric phenomenon can be reduced. Moreover, by reducing the dimension D1, the influence on the dimensions of the first external electrode 14a and the second external electrode 14b can be reduced as much as possible.

The dimension D1 can be such that 0 μm≤D1. Specifically, the dimension D1 and the dimension D2 satisfy the relation D1<D2. Therefore, the dimension of each projecting part 40 in the W direction may be set so as to gradually decrease from the center, in the L direction, of the multilayer ceramic capacitor 10 toward both ends. In this case, the dimension D1 may reduce to 0 μm at a point before an end of the ceramic body 11 in the L direction.

Moreover, the dimension D2 and the width W[10] of the multilayer ceramic capacitor 10 satisfy the following relation. Specifically, the dimension D2 satisfies the relation 0 μm<D2≤W[10]× 1/10. The relation 0 μm<D2 means that the dimension D2 is larger than 0 μm and that the extending portion 40b is always present, so that a portion overlapping the capacitive part 16 is provided. In this manner, the projecting part 40 can function to reinforce the capacitive part 16.

It should be noted that the dimension of each projecting part 40 in the W direction may be set so as to gradually decrease from the center, in the L direction, of the multilayer ceramic capacitor 10 toward both ends, as described above. Therefore, the dimension D2 may reduce to 0 μm at a point before an end region Ars, and the projecting part 40 may not be observed in a cross-section other than the cross-section taken along line B-B. Specifically, it is only necessary that the condition 0 μm<D2 be satisfied in a cross-section included in the central region Arc, and D2 may be 0 μm in other cross-sections.

The relation D2≤W[10]× 1/10, i.e., the relation between the dimension D2 and 1/10 of the width W[10] of the multilayer ceramic capacitor 10, is defined as the condition for ensuring the moisture resistance of the multilayer ceramic capacitor 10. A method for manufacturing the multilayer ceramic capacitor 10 in the present embodiment will be described later in detail. In this method, the projecting parts 40 are formed by pressing a sheet member forming the side margin part 19 to form spread portions and deforming the spread portions so as to be wrapped around edges of the principal faces. Therefore, the dimension D2 of each projecting part 40 and the thickness t19c of the corresponding side margin part 19 particularly in the central region Arc (see FIG. 5B) are correlated. Specifically, as the dimension D2 of the projecting part 40 increases, the thickness t19c of the side margin part 19 decreases accordingly. If the thickness t19c of the side margin part 19 is excessively small, the moisture resistance of the multilayer ceramic capacitor 10 may decrease. Therefore, in the present embodiment, by maintaining the relation D2≤W[10]× 1/10, the moisture resistance of the multilayer ceramic capacitor 10 is ensured. It should be noted that the thickness t19b of the side margin part 19 in the end region Ars shown in FIG. 5A tends to be larger than the thickness t19c of the side margin part 19 in the central region Arc. Therefore, in the present embodiment, the upper limit is set for the dimension D2, which is closely correlated with the thickness t19c of the side margin part 19 on which strict conditions are imposed.

Next, when the dimension M1 of the projecting part 40 in the end region Ars is compared with the dimension M2 of the projecting part 40 in the central region Arc, the relation M1<M2 holds. This is because, since increasing the dimension M2 of the portion overlapping the capacitive part 16 can reinforce the capacitive part 16, the expansion and distortion of the capacitive part 16 caused by a piezoelectric phenomenon can be reduced. Moreover, by reducing the dimension M1, the influence on the dimensions of the first external electrode 14a and the second external electrode 14b can be reduced as much as possible.

The dimension M1 and the height T[10] of the multilayer ceramic capacitor 10 satisfy the following relation. Specifically, the dimension M1 satisfies the relation 0 μm≤M1<T[10]× 1/20. When this relation is satisfied, the influence of bulging caused by the surface tension of the external electrode material when the first external electrode 14a and the second external electrode 14b are formed can be reduced.

The dimension T[10] of the multilayer ceramic capacitor 10 shown in FIG. 6A will be described in comparison with the dimension T[100] of a multilayer ceramic capacitor 100 in a comparative embodiment shown in FIG. 6C. The multilayer ceramic capacitor 100 in the comparative embodiment differs from the multilayer ceramic capacitor 10 in the embodiment in that no projecting parts 40 are provided.

It is known that, when the external electrodes are formed, central portions, in the T direction, of the electrodes and their central portions in the W direction tend to increase in thickness due to the influence of the surface tension of the material forming the external electrodes. Therefore, the dimension T[100] of the multilayer ceramic capacitor 100 in the comparative embodiment is the distance between the outermost positions, in the T direction, of a first external electrode 114a. It should be noted that in some cases, the dimension T[100] of the multilayer ceramic capacitor 100 in the comparative embodiment is the distance between the outermost positions, in the T direction, of an unillustrated second external electrode.

On the other hand, the dimension T[10] of the multilayer ceramic capacitor 10 in the embodiment is the distance between the outermost position, in the T direction, of the first external electrode 14a or the second external electrode 14b. The outermost positions, in the T direction, of the first external electrode 14a or the second external electrode 14b are located at a substantially central portion, in the W direction, of the multilayer ceramic capacitor 10.

However, if the dimension D1 is excessively large, the portions of the external electrodes that coat the projecting parts 40 may project beyond the outermost positions, in the T direction, of the central portions, in the W direction, of the external electrodes. In this case, the portions of the external electrodes that coat the projecting parts 40 are the outermost positions, in the T direction, of the external electrodes. This results in an increase in size of the multilayer ceramic capacitor 10.

When the relation M1<T[10]× 1/20 is satisfied, the height T[10] of the multilayer ceramic capacitor 10 is not influenced. Specifically, the portions of the external electrodes that coat the projecting parts 40 are prevented from becoming the outermost positions, in the T direction, of the external electrodes, and the multilayer ceramic capacitor 10 can be prevented from increasing in size.

Since 0 μm≤M1, the dimension of the projecting parts 40 in the T direction in the end regions Ars may be 0 μm. The dimension M1 and the dimension M2 satisfy the relation M1<M2. Therefore, the dimension in the T direction can gradually decrease from the central portion, in the L direction, of the multilayer ceramic capacitor 10 toward both ends. In this case, the dimension M1 may reduce to 0 μm at a point before an end, in the L direction, of the ceramic body 11.

Referring to FIG. 6A, since the multilayer ceramic capacitor 10 in the embodiment has the projecting parts 40, portions of the first external electrode 14a that coat the projecting parts 40 bulge, and stepped portions 14al with a height G[10] are formed between the central portions in the W direction and the bulging portions. Such stepped portions are formed also in the second external electrode 14b.

However, in the multilayer ceramic capacitor 100 in the comparative embodiment shown in FIG. 6C, no stepped portions are formed, and the surface shape of the first external electrode 114a includes curved portions extending continuously from portions covering principal faces 110c to portions covering side faces 110b. As described above, since no stepped portions are provided in the comparative embodiment, the distance between a principal face 110c and an outermost position, in the T direction, of the first external electrode 114a is defined as height G[100].

When the height G[10] of the stepped portions 14al in the embodiment is compared with the height G[100] in the comparative embodiment, the relation G[10]<G[100] holds. Therefore, the multilayer ceramic capacitor 10 in the embodiment is less likely to roll than the multilayer ceramic capacitor 100 in the comparative embodiment. Also, the comparative embodiment includes the curved portions extending continuously from the portions covering the principal faces 110c to the portions covering the side faces 110b. However, in the embodiment, the surface shapes of portions extending continuously via the stepped portions 14a1 are nearly flat. Because also of this shape, the multilayer ceramic capacitor 10 in the embodiment is unlikely to roll. Since the multilayer ceramic capacitor 10 is unlikely to roll, it can be mounted stably.

Next, the dimension M2 will be described. The dimension M2 and the dimension T[10] satisfy the following relation. Specifically, the relation M2≤T[10]× 1/10 is satisfied. If the dimension M2 is excessively large, the protrusion may project beyond the outermost positions, in the T direction, of the external electrodes. Accordingly, when the relation M2≤T[10]× 1/10 is maintained, the height T[10] of the multilayer ceramic capacitor 10 can be defined as the distance between the outermost positions, in the T direction, of the first external electrode 14a or the second external electrode 14b. In this manner, the multilayer ceramic capacitor 10 can be prevented from increasing in size.

### [Method for Manufacturing Multilayer Ceramic Capacitor 10]

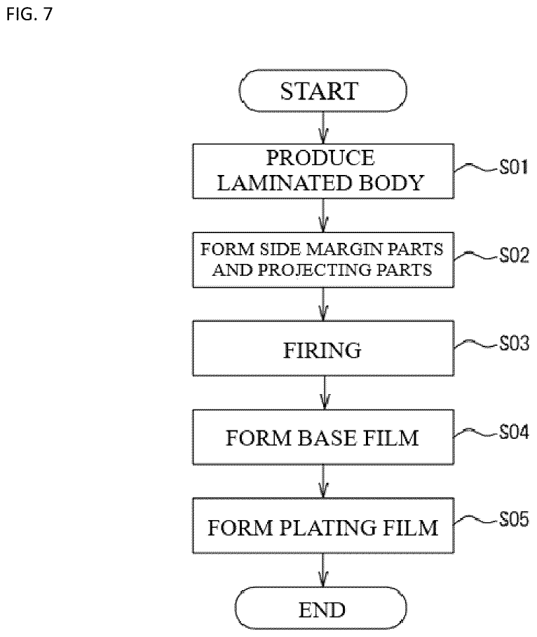

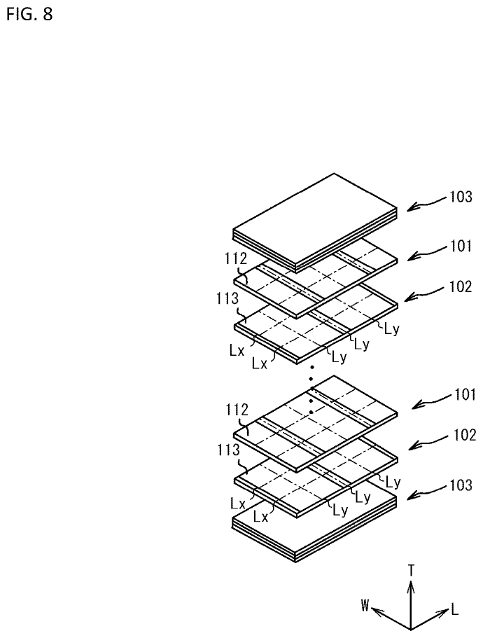

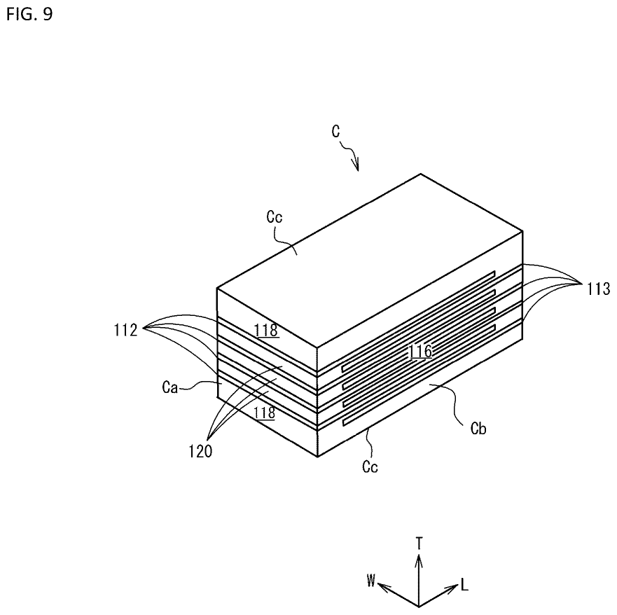

Next, an example of the method for manufacturing the multilayer ceramic capacitor 10 will be described. FIG. 7 is a flowchart showing the method for manufacturing the multilayer ceramic capacitor 10. FIGS. 8 to 13 are illustrations schematically showing the process for manufacturing the multilayer ceramic capacitor 10. The method for manufacturing the multilayer ceramic capacitor 10 will be described using FIG. 9 with appropriate reference made to FIGS. 8 to 13.

### (Step S01: Producing of Laminated Body C)

In step S01, ceramic sheets 101 and ceramic sheets 102 for forming the capacitive part 16 and ceramic sheets 103 for forming the cover parts 18 are laminated and cut to produce an unsintered ceramic laminated body (laminated body) C.

The ceramic sheets 101, 102, and 103 shown in FIG. 8 are formed as unsintered dielectric green sheets each containing a ceramic material including a dielectric ceramic, an organic binder, and additional additives. In each of the ceramic sheets 101, an unsintered first internal electrode layer 112 corresponding to the first internal electrode layer 12 is formed. In each of the ceramic sheets 102, an unsintered second internal electrode layer 113 corresponding to the second internal electrode layer 13 is formed. In each of the ceramic sheets 103, no internal electrode layer is formed.

The unsintered internal electrode layers 112 and 113 each have a pattern including a plurality of band-shaped electrodes that cross cutting lines Lx parallel to the L direction and extend along cutting lines Ly parallel to the W direction. The unsintered internal electrode layers 112 and 113 are formed by applying an electroconductive paste to the ceramic sheets 101 and 102 by, for example, a printing method.

As shown in FIG. 8, the ceramic sheets 101 and 102 are laminated alternately in the T direction. The ceramic sheets 101 and 102 formed as laminate bodies correspond to the capacitive part 16 and the end margins 20. The ceramic sheets 103 are laminated on the upper and lower surfaces, in the T direction, of the ceramic sheets 101 and 102 formed as the laminate bodies. The ceramic sheets 103 formed as laminate bodies correspond to the cover parts 18. It should be noted that the number of ceramic sheets 101, 102, and 103 laminated together can be appropriately adjusted.

Next, the ceramic sheets 101, 102, and 103 formed as the laminate bodies are pressure-bonded together in the T direction and then cut along the cutting lines Lx and Ly. A laminated body C shown in FIG. 9 is thereby produced.

The laminated body C includes an unsintered capacitive part 116 including the unsintered internal electrode layers 112 and 113, unsintered cover parts 118, and unsintered end margins 120. The laminated body C has side faces Cb that are cut surfaces corresponding to the cutting lines Lx and end faces Ca that are cut surfaces corresponding to the cutting lines Ly. Ends of the unsintered internal electrode layers 112 and 113 are exposed at the side faces Cb.

### (Step S02: Formation of Side Margin Parts 119 and Projecting Parts 140)

In step S02, side margin parts 119 are formed on the side faces Cb of the laminated body C, and projecting parts 140 are formed. An example of the formation method will be shown.

First, a ceramic sheet 104 for the side margin parts 119 is prepared. The ceramic sheet 104 is formed as an unsintered dielectric green sheet containing a ceramic material including a dielectric ceramic, an organic binder, and additional additives. In the ceramic sheet 104, the content of a plasticizer is higher than that in the ceramic sheets 101 to 103 in order for the ceramic sheet 104 to deform easily at a lower temperature and a lower pressure. Also, the compositional makeup of the ceramic sheet 104 is adjusted by increasing the plasticizer content or by increasing the amount of a resin such as a binder in addition to or instead of increasing the plasticizer content.

The ratios of increase can be set as follows. Specifically, while the amount of the plasticizer in the laminated body C is 0 wt % to 1 wt % based on the amount of the dielectric material, the amount of the plasticizer in the side margin parts 119 may be 2 wt % to 4 wt % based on the amount of the dielectric material. Moreover, while the amount of the binder in the laminated body C is 2 wt % to 11 wt % based on the amount of the dielectric material, the amount of the binder in the side margin parts 119 may be 12 wt % to 20 wt % based on the amount of the dielectric material. In this manner, each unsintered side margin part 119 is allowed to deform easily.

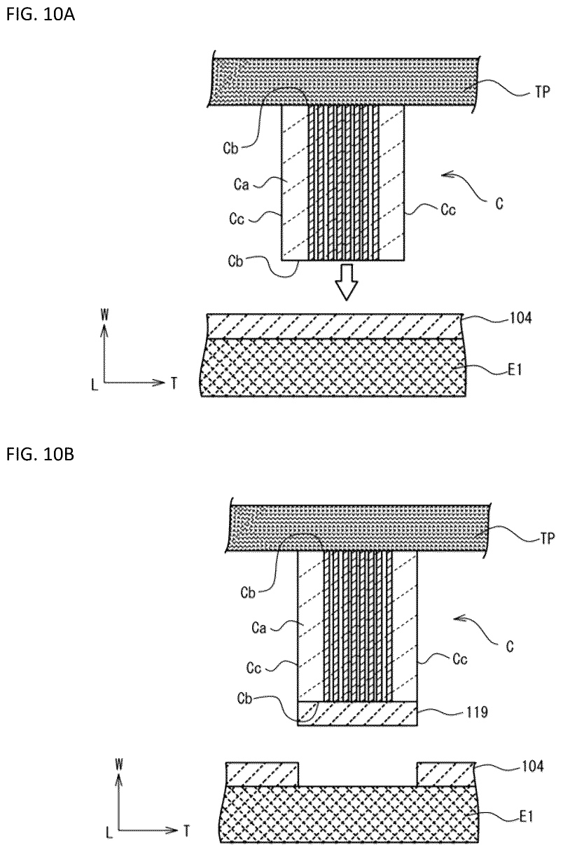

To form the side margin part 119 using the ceramic sheet 104, the ceramic sheet 104 is first placed on a first elastic material E1 having a flat plate shape as shown in FIG. 10A. Then one side face Cb of the laminated body C is held by a tape TP, and the laminated body C is disposed such that the other side face Cb faces the ceramic sheet 104. The first elastic material E1 is formed, for example, of an elastic material such as rubber.

Next, as shown in FIG. 10B, the ceramic sheet 104 is punched using the side face Cb of the laminated body C, and the ceramic sheet 104 thereby adheres to the side face Cb. Specifically, the laminated body C is strongly pressed against the ceramic sheet 104 in the W direction. In this manner, the laminated body C, together with the ceramic sheet 104, locally sinks deep into the first elastic material E1. In this case, a shearing force acts on the ceramic sheet 104 along the outer edges of the side face Cb. When the shearing force reaches or exceeds the shear strength of the ceramic sheet 104, the ceramic sheet 104 is punched. Then part of the ceramic sheet 104 that has sunk together with the laminated body C is separated. The side margin part 119 is thereby formed on the side face Cb.

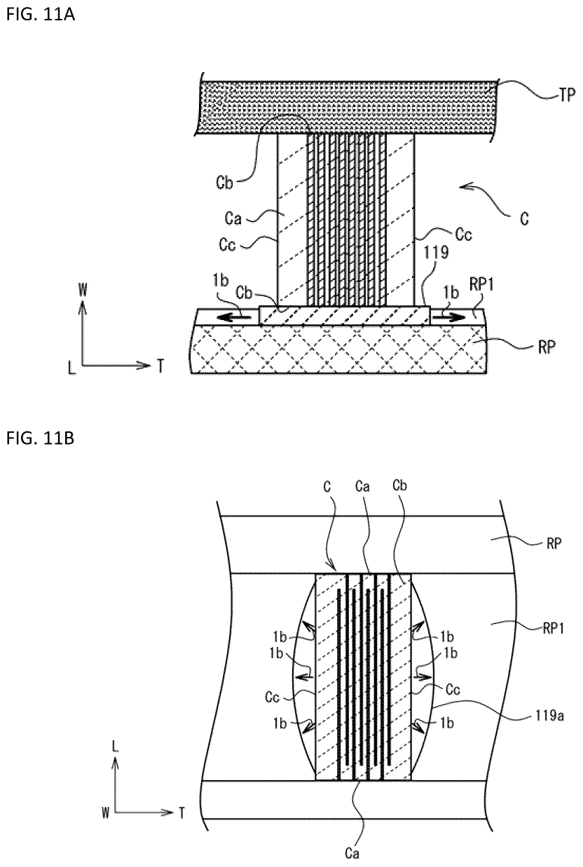

Referring next to FIGS. 11A and 11B, the step of producing spread portions 119a will be described. The spread portions 119a later become unsintered projecting parts 140. To manufacture the spread portions 119a, the side margin part 119 formed from a sheet member, i.e., the ceramic sheet 104, on the side face Cb of the laminated body C is pressed against a rigid plate RP. In this manner, the side margin part 119 spreads in the T direction as indicated by arrows 1b. Portions of the side margin part 119 that have spread widely beyond the region of the laminated body C become the spread portions 119a. The rigid plate RP includes a spread-preventing portion RP1 that prevents the ceramic sheet 104 forming the side margin part 119 from spreading toward the pair of end faces Ca of the laminated body C that face each other in the L direction. The spread-preventing portion RP1 is a groove-shaped member having a width corresponding to the dimension of the laminated body C in the L direction. The end faces Ca are each a portion on which the first external electrode 14a or the second external electrode 14b is to be formed. Therefore, it is necessary to prevent the ceramic sheet 104 from deforming and extending to the end faces Ca. By providing the groove-shaped spread-preventing portion RP1, the spread of the ceramic sheet 104 that can possibly deform and extend to the end faces Ca can be prevented.

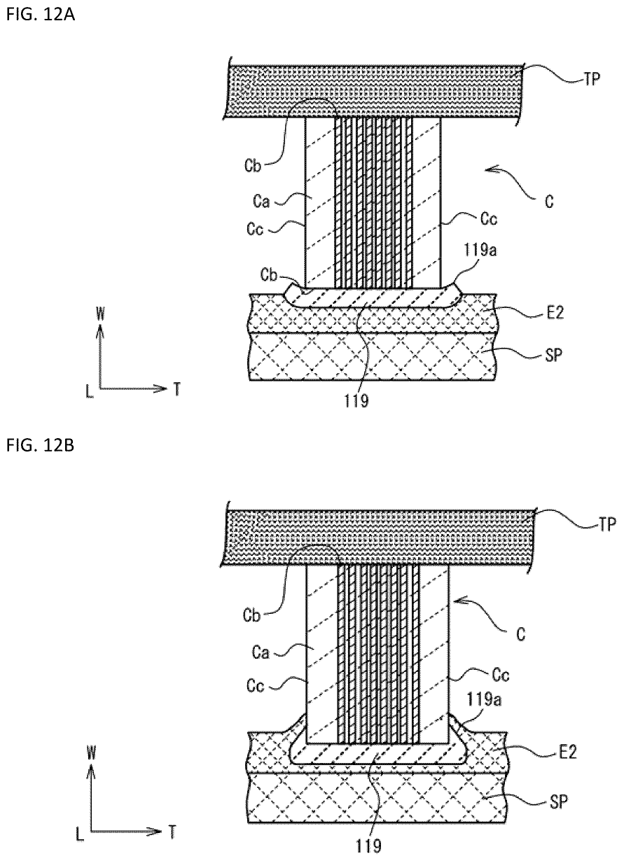

Referring next to FIGS. 12A and 12B, the step of forming unsintered projecting parts 140 projecting outwards from the laminated body C in the T direction will be described. Specifically, as shown in FIG. 12A, the side margin part 119 having the spread portions 119a is pressed against a second elastic material E2 having a flat plate shape. The second elastic material E2 is disposed on a highly rigid support plate SP. The second elastic material E2 is formed of an elastic material such as rubber, but its harness is lower than the hardness of the first elastic material E1. In this case, the side margin part 119 can sink inward into the second elastic material E2, as shown in FIG. 12B. As a result, the spread portions 119a deform and extend along the principal faces Cc of the laminated body C, and projecting parts are thereby formed.

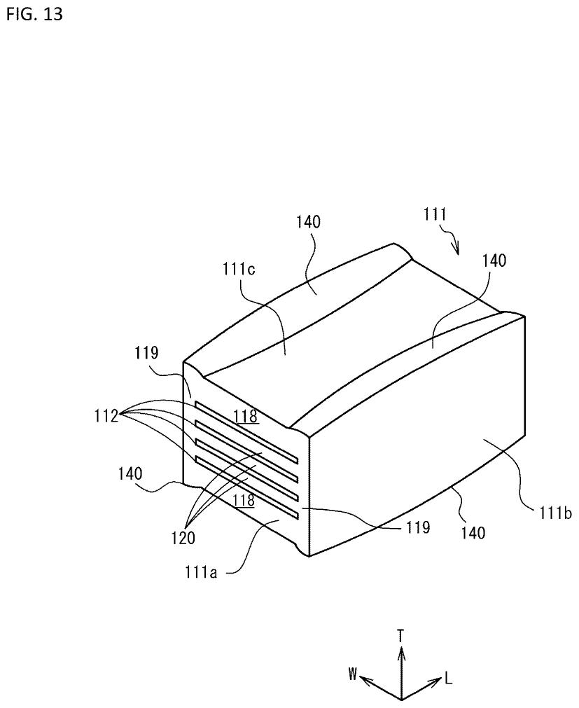

Accordingly, a side margin part 119 is also formed on the other side face Cb, and then projecting parts 140 are formed. In this manner, an unsintered ceramic body 111 shown in FIG. 13 is produced.

### (Step S03: Firing)

In step S03, the unsintered ceramic body 111 obtained in step S02 is fired to produce the ceramic body 11 in the multilayer ceramic capacitor 10 shown in FIG. 1. The firing temperature in step S03 can be determined based on the sintering temperature of the ceramic body 111. Also, the firing can be performed, for example, in a reducing atmosphere or a low-oxygen partial pressure atmosphere.

### (Step S04: Formation of Base Film)

In step S04, the electroconductive base film 21 is formed on the end faces 11a, the side faces 11b, and the principal faces 11c shown in FIGS. 3A, 4B, etc.

The base film 21 is formed by applying an unsintered electrode material to the end faces 11a, the side faces 11b, and the principal faces 11c. For example, a dipping method is used for application. However, any other well-known method such as a printing method, a sputtering method, etc. or a combination of these methods may be used. Next, the unsintered electrode material is baked. The baking can be performed, for example, in a reducing atmosphere or a low-oxygen partial pressure atmosphere.

### (Step S05: Formation of Plating Film)

In step S05, the multilayer ceramic capacitor 10 with the base film 21 formed thereon is immersed in a plating solution for forming the plating film 22 to perform electroplating. The plating film 22 is thereby formed.

In the manner described above, the multilayer ceramic capacitor 10 shown in FIGS. 1 to 3 is manufactured.

### [Modifications]

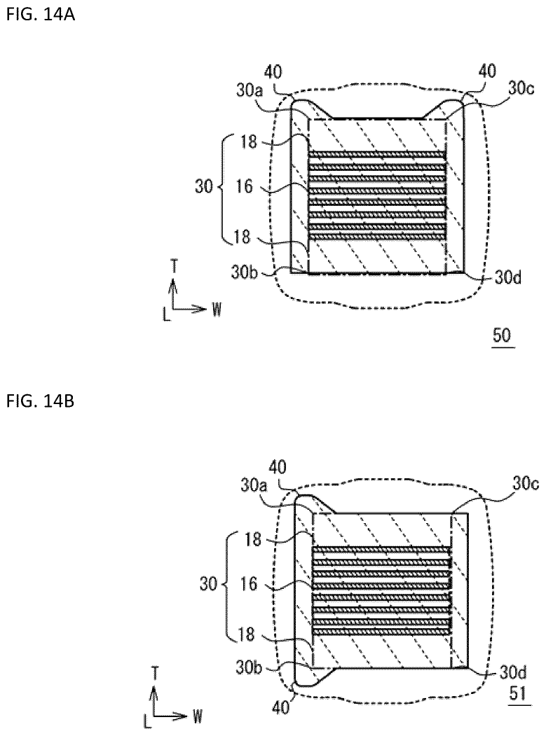

Next, modifications will be described with reference to FIGS. 14A and 14B. The above-described multilayer ceramic capacitor 10 in the embodiment includes the four projecting parts 40 at the four ridge portions of the ceramic body 11. Therefore, as shown in FIGS. 4A and 4B, the four projecting parts 40 are present in the cross sections including the T and W directions. However, in a multilayer ceramic capacitor 50 in a modification shown in FIG. 14A, projecting parts 40 are formed only on one side of pairs of ridge portions opposed to each other in the T direction in a cross-section including the T and W directions. Also, in a multilayer ceramic capacitor 51 in another modification shown in FIG. 14B, projecting parts 40 are formed only on one side of pairs of ridge portions opposed to each other in the W direction in a cross-section including the T and W directions. In these modifications, the projecting parts are provided at two of the four ridge portions. The projecting parts may be disposed at a pair of ridge portions located on a diagonal line in the cross-section including the T and W directions. Further, one projecting part may be provided at one ridge portion in the cross-section including the T and W directions.

The embodiments of the invention have been described. However, the invention is not limited only to the embodiments described above, and it will be appreciated that various modifications can be made within the scope of the invention.

### EXAMPLES

### [Evaluation of Moisture Resistance and Withstand Voltage]

First, the results of the evaluation of moisture resistance and the withstand voltage in Examples and Comparative Examples will be described. The Examples correspond to the multilayer ceramic capacitor 10 in the embodiment and have dimensions described below. The Examples and Comparative Examples differ with respect to the dimension D2. The dimension D2 was measured at a position spaced from one end, in the L direction, of the multilayer ceramic capacitor 10 shown in FIG. 1B in the direction indicated by arrow 1a by ½ of the dimension L[10] of the multilayer ceramic capacitor 10 in the L direction. The dimension D2 was measured on the image of a cross-section observed under an SEM (Scanning Electron Microscope). Also, the width W[10] of the multilayer ceramic capacitor 10 was measured using a length-measuring microscope. Specifically, the dimension of the portion of the multilayer ceramic capacitor 10 having the maximum dimension in the W direction was measured. The number of measurements n was 20. The average of the measurements was used as the width W[10] of the multilayer ceramic capacitors 10 used for the measurement.

The conditions for the moisture resistance evaluation test are shown below.

### Test Conditions:

Ambient temperature: 40° C., ambient humidity: 95%

### Rated Voltage:

500 hr.

### Dimensions of Test Samples:

$$1005 ( length \times width \times height = 1. mm \times 0.5 mm \times 0.5 mm )$$

### Number of Test Samples:

1000 for each of the Examples and Comparative Examples.

To measure the withstand voltage, the impressed voltage to the multilayer ceramic capacitor 10 was continuously increased, and the value of the impressed voltage when the current exceeded 50 mA was used as the withstand voltage.

TABLE 1

| | Comparative | Example | Example | Example | Comparative | Comparative |
|---|---|---|---|---|---|---|
| | Example 1 | 1 | 2 | 3 | Example 2 | Example 3 |
| D2 | 0 | 1/30 · W | 1/20 · W | 1/10 · W | 1/9 · W | ⅕ · W |
| Moisture resistance | 0 | 0 | 0 | 0 | 0.1 | 1 |
| NG rate (%) | | | | | | |
| Withstand voltage (V) | 120 | 122 | 125 | 135 | 135 | 137 |

### Example 1

The dimension D2 in Example 1 is represented by dimension D2=width W[10]× 1/30. Specifically, the dimension D2 is 1/30 of the width W[10]. In Example 1, the moisture resistance failure rate (hereinafter referred to as the moisture resistance NG rate) was 0%. The withstand voltage was 122 V. It should be noted that when the insulation resistance value of a multilayer ceramic capacitor 10 measured at the rated voltage was lower than 1 MΩ, the moisture resistance was rated NG.

### Example 2

The dimension D2 in Example 2 is represented by dimension D2=width W[10]× 1/20. Specifically, the dimension D2 is 1/20 of the width W[10]. In Example 2, the moisture resistance NG rate was 0%. The withstand voltage was 125 V.

### Example 3

The dimension D2 in Example 3 is represented by dimension D2=width W[10]× 1/10. Specifically, the dimension D2 is 1/10 of the width W[10]. In Example 3, the moisture resistance NG rate was 0%. The withstand voltage was 135 V.

### Comparative Example 1

The dimension D2 in Comparative Example 1 is represented by dimension D2=0. Specifically, in Comparative Example 1, no projecting parts 40 are provided. In Comparative Example 1, the moisture resistance NG rate was 0%. The withstand voltage was 120 V.

### Comparative Example 2

The dimension D2 in Comparative Example 2 is represented by dimension D2=width W[10]× 1/9. Specifically, the dimension D2 is 1/9 of the width W[10]. In Comparative Example 2, the moisture resistance NG rate was 0.1%. The withstand voltage was 135 V.

### Comparative Example 3

The dimension D2 in Comparative Example 3 is represented by dimension D2=width W[10]×⅕. Specifically, the dimension D2 is ⅕ of the width W[10]. In Comparative Example 2, the moisture resistance NG rate was 1%. The withstand voltage was 137 V.

In Table 1, the further to the right, the larger the dimension D2. The further to the right, the larger the withstand voltage. Specifically, as the dimension D2 increases, the withstand voltage increases. This may be because, as the dimension D2 increases, the region of the projecting parts 40 that overlaps the capacitive part 16 increases.

However, in Comparative Examples 2 and 3, the moisture resistance was rated poor in some cases. This may be because, as the dimension D2 increases, the thickness t19c of the side margin parts 19 decreases accordingly.

In consideration of the above, the appropriate range of the dimension D2 is 0 μm<D2≤W[10]× 1/10. When the dimension D2 is within this range, the reliability at high voltages is improved. Moreover, without increasing the thickness of the side margin parts 19, the capacitance of the multilayer ceramic capacitor 10 can be increased, and its size can be reduced.

### [Rate of Variation in Height T[10]]

Next, the rate of variation in the height T[10] is examined in relation to the dimension M1. The height T[10] is set as follows. First, on the assumption that the outermost positions, in the T direction, of the first external electrode 14a or the second external electrode 14b are located at the central portion in the W direction. Specifically, the dimension, in the T direction, of the first external electrode 14a or the second external electrode 14b at the central portion in the W direction is used as the height T[10]. The height T[10] was measured using a length-measuring microscope. Specifically, the dimension of the multilayer ceramic capacitor 10 in the T direction at the position where the dimension reached its maximum was measured. The number of measurements n was n=20. The average value was used as the height T[10] of the multilayer ceramic capacitors 10 used for the measurement. Alternatively, to measure the height T[10], the distance between the outermost positions of the first external electrode 14a and the distance between the outermost positions of the second external electrode 14b are measured, and the larger one of the distances may be used. Also, the rate of variation in the height T[10] may be evaluated for each of the first external electrode 14a and the second external electrode 14b.

The rate of variation in the height T[10] is used to evaluate the extent to which the dimension in the T direction measured at a point other than the above-described measurement point of the height T[10] exceeds the height T[10]. Therefore, when the dimension in the T direction measured at a point other than the measurement point of the height T[10] is smaller than the height T[10], the rate of variation in the height T[10] is evaluated as 0%.

Examples correspond to the multilayer ceramic capacitor 10 in the embodiment, and their dimensions are shown below. The Examples and Comparative Example differ with respect to the dimension M1. The dimension M1 was measured at a position spaced from one end, in the L direction, of the multilayer ceramic capacitor 10 shown in FIG. 1B in the direction indicated by arrow 1a by 1/20 of the dimension L[10] of the multilayer ceramic capacitor 10 in the L direction. The dimension M1 was measured in a cross-sectional image taken under an SEM.

### Dimensions of Test Samples:

$$1005 ( length \times width \times heigh = 1. mm \times 0.5 mm \times 0.5 mm )$$

TABLE 2

| | Compar- | | | Compar- | Compar- |
|---|---|---|---|---|---|
| | ative | | | ative | ative |
| | Example | Example | Example | Example | Example |
| | 4 | 4 | 5 | 5 | 6 |
| M1 | 0 | 1/30 · T | 1/20 · T | 1/10 · T | 1/9 · T |
| Rate of | 0 | 0 | 0 | 5 | 6 |
| variation in | | | | | |
| T dimension | | | | | |
| (%) | | | | | |

### Example 4

The dimension M1 in Example 4 is represented by dimension M1=height T[10]× 1/30. Specifically, the dimension M1 is 1/30 of the height T[10]. In Example 4, the rate of variation in the height T (hereinafter referred to as the rate of variation in T dimension) was 0%.

### Example 5

The dimension M1 in Example 5 is represented by dimension M1=height T[10]× 1/20. Specifically, the dimension M1 is 1/20 of the height T[10]. In Example 5, the rate of variation in T dimension was 0%.

### Comparative Example 4

The dimension M1 in Comparative Example 4 is represented by dimension M1=0. Specifically, in Comparative Example 4, no projecting parts 40 are provided. In Comparative Example 4, the rate of variation in T dimension was 0%.

### Comparative Example 5

The dimension M1 in Comparative Example 5 is represented by dimension M1=height T[10]× 1/10. Specifically, the dimension M1 is 1/10 of the height T[10]. In Comparative Example 5, the rate of variation in T dimension was 5%.

### Comparative Example 6

The dimension M1 in Comparative Example 6 is represented by dimension M1=height T[10]× 1/9. Specifically, the dimension M1 is 1/9 of the height T[10]. In Comparative Example 6, the rate of variation in T dimension was 6%.

In Table 2, further to the right, the larger the dimension M1. As the dimension M1 increases such that the dimension M1≥the height T[10]× 1/10, the rate of variation in T dimension becomes larger than 0. This is because, when the dimension M1 of the projecting parts 40 is large, the outermost positions, in the T direction, of the multilayer ceramic capacitor 10 shift outward in the W direction from the central portion, in the W direction, of the first external electrode 14a or the second external electrode 14b. Therefore, in Comparative Examples 5 and 6, the multilayer ceramic capacitor 10 was increased in size.

In consideration of the above, the appropriate range of the dimension M1 is 0 μm≤M1<T[10]/20. When the dimension M1 is within this range, the reliability at high voltages is improved. Moreover, without increasing the thickness of the side margin parts 19, the capacitance of the multilayer ceramic capacitor 10 can be increased, and its size can be reduced.

Next, the rate of variation in the height T[10] is examined in relation to the dimension M2. The height T[10] is set in the same manner as described above, and its detailed description is omitted.

Examples correspond to the multilayer ceramic capacitor 10 in the embodiment, and their dimensions are shown below. The Examples and Comparative Example differ with respect to the dimension M2. The dimension M2 was measured at a position spaced from one end, in the L direction, of the multilayer ceramic capacitor 10 shown in FIG. 1B in the direction indicated by arrow 1a by ½ of the dimension L[10] of the multilayer ceramic capacitor 10 in the L direction. The dimension M2 was measured in a cross-sectional image taken under an SEM.

### Dimensions of Test Samples:

$$1005 ( length \times width \times height = 1. mm \times 0.5 mm \times 0.5 mm )$$

TABLE 3

| | Comparative | Example | Example | Example | Comparative | Comparative |
|---|---|---|---|---|---|---|
| | Example 7 | 6 | 7 | 8 | Example 8 | Example 9 |
| M2 | 0 | 1/30 · T | 1/20 · T | 1/10 · T | 1/9 · T | ⅕ · T |
| Rate of variation | 0 | 0 | 0 | 0 | 1 | 20 |
| in T dimension (%) | | | | | | |

### Example 6

The dimension M2 in Example 6 is represented by dimension M2=height T[10]× 1/30. Specifically, the dimension M2 is 1/30 of the height T[10]. In Example 6, the rate of variation in T dimension was 0%.

### Example 7

The dimension M2 in Example 7 is represented by dimension M2=height T[10]× 1/20. Specifically, the dimension M2 is 1/20 of the height T[10]. In Example 7, the rate of variation in T dimension was 0%.

### Example 8

The dimension M2 in Example 8 is represented by dimension M2=height T[10]× 1/10. Specifically, the dimension M2 is 1/10 of the height T[10]. In Example 8, the rate of variation in T dimension was 0%.

### Comparative Example 7

The dimension M2 in Comparative Example 7 is represented by dimension M2=0. Specifically, in Comparative Example 7, no projecting parts 40 are provided. In Comparative Example 7, the rate of variation in T dimension was 0%.

### Comparative Example 8

The dimension M2 in Comparative Example 8 is represented by dimension M2=height T[10]× 1/9. Specifically, the dimension M2 is 1/9 of the height T[10]. In Comparative Example 8, the rate of variation in T dimension was 1%.

### Comparative Example 9

The dimension M2 in Comparative Example 9 is represented by dimension M2=height T[10]×⅕. Specifically, the dimension M2 is ⅕ of the height T[10]. In Comparative Example 9, the rate of variation in T dimension was 20%.

In Table 3, the further to the right, the larger the dimension M2. As the dimension M2 increases such that the dimension M2≥the height T[10]× 1/9, the rate of variation in T dimension becomes larger than 0. This is because, when the dimension M2 of the projecting parts 40 is large, the outermost positions, in the T direction, of the multilayer ceramic capacitor 10 shift from the central portion, in the W direction, of the first external electrode 14a or the second external electrode 14b to a central portion in the L direction. Therefore, in Comparative Examples 8 and 9, the multilayer ceramic capacitor 10 was increased in size.

In consideration of the above, the appropriate range of the dimension M2 is M2≤T[10]× 1/10. When the dimension M2 is within this range, the reliability at high voltages is improved. Moreover, without increasing the thickness of the side margin parts 19, the capacitance of the multilayer ceramic capacitor 10 can be increased, and its size can be reduced.

In the above embodiments, the multilayer ceramic capacitor 10 has been described as an example of a multilayer ceramic electronic component. However, the present invention is applicable broadly to multilayer ceramic electronic components including dielectric layers and internal electrode laminated together. Examples of such multilayer ceramic electronic components include chip varistors, chip thermistors, and multilayer inductors.

What is claimed:

1. A multilayer ceramic electronic component comprising:
an element body that includes a laminated body including a capacitive part formed by alternately laminating first internal electrode layers and second internal electrode layers in a first direction with dielectric layers interposed therebetween and further including a pair of cover parts covering the capacitive part from both sides in the first direction and that further includes a side margin part covering the laminated body in a second direction orthogonal to the first direction, the element body having a pair of principal faces facing each other in the first direction;
a first external electrode that is formed on a surface of the element body and that is connected to the first internal electrode layers; and
a second external electrode that is formed on a surface of the element body so as to be spaced apart from the first external electrode and that is connected to the second internal electrode layers,
wherein the laminated body has a plurality of ridge portions extending in a third direction orthogonal to the first direction and the second direction, and
wherein the element body has a projecting part at at least one of the plurality of ridge portions, wherein the projecting part is continuous from the side margin part, extends in the third direction, and, in a cross-section defined by the first direction and the second direction, projects outward in the first direction beyond a center point of one of the principal faces as viewed in the second direction, as well as spreads toward the center point of the one of the principal faces in the second direction beyond a boundary line between the laminated body and the side margin part.

2. The multilayer ceramic electronic component according to claim 1, wherein
in plan view where the one of the principal faces is observed, the projecting part includes a central region at least partially overlapping the capacitive part, and end regions extending in the third direction on both sides of the central region, and
a dimension D1 of an extending portion that extends beyond the boundary line in the second direction in each of the end regions, is smaller than a dimension D2 of an extending portion that extends beyond the boundary line in the second direction in the central region.

3. The multilayer ceramic electronic component according to claim 1, wherein
in plan view where the one of the principal faces is observed, the projecting part includes a central region at least partially overlapping the capacitive part and end regions extending in the third direction on both sides of the central region, and
a dimension M1 of the projecting part in the first direction in each of the end regions is smaller than a dimension M2 of the projecting part in the first direction in the central region.

4. The multilayer ceramic electronic component according to claim 2, wherein the dimension D1, in the second direction, of the extending portion extending beyond the boundary line in each of the end regions and the dimension D2, in the second direction, of the extending portion extending beyond the boundary line in the central region satisfy the following relations:
$$0 μm \leq D 1 , and$$
$$0 μm < D 2 \leq W \times 1 / 10 ,$$
where W is a dimension of the multilayer ceramic electronic component in the second direction.

5. The multilayer ceramic electronic component according to claim 3, wherein the dimension M1 of the projecting part in the first direction in each of the end regions satisfies the following relation:
$$0 μm \leq M 1 < T \times 1 / 20 ,$$
where T is a dimension of the multilayer ceramic electronic component in the first direction, and
wherein the dimension M2 of the projecting part in the first direction in the central region satisfies the following relation:
$$0 μm < M 2 \leq T \times 1 / 10.$$

6. The multilayer ceramic electronic component according to claim 1, wherein the projecting part is formed in at least one of two ridge portions of the plurality of ridge portions paired in the first direction, the two ridge portions being paired and facing each other in the first direction in the cross-section defined by the first direction and the second direction.

7. The multilayer ceramic electronic component according to claim 1, wherein the projecting part is formed in at least one of two ridge portions of the plurality of ridge portions paired in the second direction, the two ridge portions being paired and facing each other in the second direction in the cross-section defined by the first direction and the second direction.

8. The multilayer ceramic electronic component according to claim 1, wherein the first external electrode and the second external electrode cover respective end faces of the element body facing each other in the third direction and extend along at least the principal faces,
wherein outermost positions of the first external electrode and the second external electrode in the first direction are located at a central portion of the element body in the second direction, and
wherein a dimension of the multilayer ceramic electronic component in the first direction is defined as a distance between the outermost positions of the first external electrode or the second external electrode in the first direction.

9. The multilayer ceramic electronic component according to claim 1, wherein end parts, in the second direction, of the first internal electrode layer and the second internal electrode layer are aligned within a range of 0.5 μm in the second direction.

10. A method for manufacturing a multilayer ceramic electronic component, the method comprising the steps of:
producing an unsintered laminated body that includes a capacitive part formed by alternately laminating dielectric layers and internal electrodes in a first direction with the internal electrodes exposed at a side face facing a second direction orthogonal to the first direction and that further includes a pair of cover parts that cover the capacitive part from both sides in the first direction;
forming a side margin part on the side face of the unsintered laminated body by pressing the side face against a sheet member placed on a first elastic material to punch the sheet member;
forming spread portions by pressing the side margin part against a rigid plate to spread the sheet member forming the side margin part over a region larger than an area of the side face in the first direction;
pressing the side margin part having the spread portions against a second elastic material such that the spread portions deform and are wrapped around edges of a pair of principal faces of the laminated body, respectively, that face each other in the first direction to form projecting parts projecting outward in the first direction, respectively, thereby obtaining an unsintered element body;
firing the element body; and
forming an external electrode on the fired element body.

11. The method for manufacturing a multilayer ceramic electronic component according to claim 10, wherein a hardness of the second elastic material is lower than a hardness of the first elastic material.

12. The method for manufacturing a multilayer ceramic electronic component according to claim 10, wherein the rigid plate includes a spread-preventing portion for preventing the sheet member forming the side margin part from spreading toward a pair of end faces of the laminated body that face each other in a third direction orthogonal to the first direction and the second direction.
